(19) United States
(12) Patent Application Publication
(10) Pub. No.: US 2010/0263932 A1
(43) Pub. Date: Oct. 21, 2010

(54) BIT RETAINER ASSEMBLY FOR A DOWN-HOLE DRILL

(76) Inventor: Dale Richard Wolfer, Salem, VA (US)

Correspondence Address: MICHAEL BEST & FRIEDRICH LLP, 100 E WISCONSIN AVENUE, Suite 3300, MILWAUKEE, WI, 53202, US

(21) Appl. No.: 12/425,222

(22) Filed: Apr. 16, 2009

(51) Int. Cl. E21B 17/04; E21B 17/046; E21B 17/06; E21B 1/00; B23B 31/10

(52) U.S. Cl. 175/57; 175/293; 279/91

(57) ABSTRACT

A retainer device for a drill bit, an earth-boring drill assembly and methods of retaining a drill bit and operating drill assembly. The earth-boring drill assembly includes a casing having a central axis, the bit having a generally cylindrical head. The retainer device includes an annular sleeve connectable to the casing and a retainer assembly provided between the sleeve and the bit. The retainer assembly includes an axial slot defined by one of the sleeve and the bit, the slot having an axially-extending side wall defining an opening and an axial end wall, and a lug supported on the other of the sleeve and the bit, the lug being positionable in the slot through the opening in the side wall, the lug being engageable with the end wall to restrict axial movement of the bit from the sleeve and away from the casing.

### FIELD OF THE INVENTION

The present invention relates to down-hole drills and, more particularly, a bit retainer assembly for such a drill.

### SUMMARY OF THE INVENTION

Down-hole drills, also known as down-hole hammers, down-the-hole (DTH) drills, and earth-boring drills, are typically fluid-operated and generally include a casing, a piston movably disposed within the casing, and a cutting bit with a cutting surface movably coupled with the casing. The piston is linearly reciprocated within the casing to repeatedly impact the bit so as the drive the cutting surface into a work surface of a hole being drilled. Typically, such drills further include a chuck threaded to the casing and for guiding the movement of the bit and/or the piston. The bit may be movably disposed within a central bore of the chuck, and the bit and chuck have complementary grooves and splines that slidably interact during movement of the bit. Further, the bit is generally secured to the chuck by means of a set of split rings that engage with the outer surface of the bit, such as with a bit groove or shoulder, so as to connect the bit with the chuck.

When a bit breaks during drilling operations, an operator must remove the broken pieces of the bit before drilling can continue. This process can be time consuming and expensive and, if unsuccessful, can result in abandonment of the hole being drilled.

It is important to provide structure to retain the broken portion of the bit with the rest of the drilling assembly so that the broken portion can be retrieved from the hole without undue delay and expense. The structure should also be reliable.

In one embodiment, the invention may provide a retainer device for a drill bit for an earth-boring drill assembly, the drill assembly including a casing having a central axis, the bit having a generally cylindrical head. The retainer device generally includes an annular sleeve connectable to the casing and a retainer assembly provided between the sleeve and the bit. The retainer assembly may include an axial slot defined by one of the sleeve and the bit, the slot having an axially-extending side wall defining an opening and an axial end wall, and a lug supported on the other of the sleeve and the bit, the lug being positionable in the slot through the opening in the side wall, the lug being engageable with the end wall to restrict axial movement of the bit from the sleeve and away from the casing.

In some constructions, the head of the bit has an outer circumferential surface, the slot is defined on the outer circumferential surface of the head of the bit, and the lug is supported by the sleeve. The lug may be integrally formed with the other of the sleeve and the bit.

In some constructions, the retainer assembly may include a first axial slot defined by one of the sleeve and the bit, the first slot having an axially-extending first side wall defining an opening, an opposite second side wall, and an end wall between the first side wall and the second side wall, a first lug supported on the other of the sleeve and the bit, the first lug being positionable in the first slot through the opening in the first side wall of the first slot, the first lug being engageable with the end wall of the first slot to restrict axial movement of the bit from the sleeve and away from the casing, a second axial slot defined by one of the sleeve and the bit, the second slot having an axially-extending first side wall defining an opening, an opposite second side wall, and an end wall between the first side wall and the second side wall, and a second lug supported on the other of the sleeve and the bit, the second lug being positionable in the second slot through the opening in the first side wall of the second slot, the second lug being engageable with the end wall of the second slot to restrict axial movement of the bit from the sleeve and away from the casing. In such constructions, the head of the bit has an outer circumferential surface, the first slot and the second slot are defined on the outer circumferential surface of the head of the bit, and the first lug and the second lug are supported by the sleeve.

In some constructions, the retainer assembly includes a plurality of axial slots defined by one of the sleeve and the bit, each of the slots having an axially-extending first side wall defining an opening, an opposite second side wall, and an end wall between the first side wall and the second side wall, the plurality of slots being circumferentially spaced about the one of the sleeve and the bit, a corresponding plurality of lugs supported on the other of the sleeve and the bit, each of the lugs being positionable in a corresponding one of the slots through the opening in the first side wall of the corresponding one of the slots, each of the lugs being engageable with the end wall of the corresponding one of the slots to restrict axial movement of the bit from the sleeve and away from the casing. The retainer assembly may include four slots and four lugs.

The retainer assembly may further include a transverse slot extending at least partially circumferentially about the one of the sleeve and the bit, the transverse slot communicating with the axial slot through the opening in the side wall of the axial slot, the lug being movable into and through the transverse slot into the axial slot. The retainer assembly may also further include an axial entry slot having an open axial end, the lug being axially engageable in the entry slot through the open axial end, and wherein the transverse slot communicates between the entry slot and the axial slot. The entry slot may have a closed axial end opposite the open axial end, and the transverse slot may communicate with the entry slot proximate the closed axial end.

The axial slot has an axial second end wall opposite the first-mentioned end wall, the opening in the side wall being between the first-mentioned end wall and the second end wall. The lug has an axial height, and the opening in the first-mentioned side wall is sized to closely fit the axial height of the lug.

In another embodiment, the invention may provide an earth-boring drill assembly generally including a casing having a central axis, a bit having a generally cylindrical head and a shank connected to the head, a chuck connected to the casing, the chuck being connected to the shank of the bit, and a retainer device. The retainer device may include an annular sleeve connectable to the chuck, and a retainer assembly provided between the sleeve and the bit. The retainer assembly generally includes an axial slot defined by one of the sleeve and the bit, the slot having an axially-extending side wall defining an opening and an axial end wall, and a lug supported on the other of the sleeve and the bit, the lug being positionable in the slot through the opening in the side wall, the lug being engageable with the end wall to restrict axial movement of the bit from the sleeve and away from the casing. In some constructions, the chuck and the sleeve include inter-engaging surfaces to axially retain the sleeve on the chuck.

During operation of the drill assembly, the bit moves an axial distance between a first operating position and a second operating position, the lug has an axial height, and the slot has an axial length greater than the total of the axial distance and the axial height of the lug. During operation of the drill assembly, the bit moves a circumferential distance between a first operating position and a second operating position, the lug has a circumferential width, and the slot has a circumferential width greater than the total of the circumferential distance and the circumferential width of the lug.

During operation of the drill assembly, the bit moves axially between a first operating position and a second operating position, and the slot and the lug are dimensioned such that the lug is engageable with the end wall of the slot in an axial position of the bit axially beyond the first operating position and the second operating position. During operation of the drill assembly, the bit moves circumferentially between a first operating position and a second operating position, the slot has a second side wall opposite the first-mentioned side wall, and the slot and the lug are dimensioned such that the lug is engageable with first-mentioned side wall of the slot in a circumferential position of the bit circumferentially beyond the first operating position and with the second side wall of the slot in a circumferential position of the bit circumferentially beyond the second operating position.

In a further embodiment, the invention may provide a method of retaining a drill bit for an earth-boring drill assembly, the drill assembly including a casing having a central axis, the bit having a generally cylindrical head. The method generally includes connecting an annular sleeve to the casing; and engaging a retainer assembly provided between the sleeve and the bit, the retainer assembly including an axial slot defined by one of the sleeve and the bit, the slot having an axially-extending first side wall defining an opening, an opposite second side wall, and an end wall between the first side wall and the second side wall, and a lug supported on the other of the sleeve and the bit. The act of engaging includes positioning the lug in the slot through the opening in the first side wall, and engaging the lug with the end wall to restrict axial movement of the bit from the sleeve and away from the casing.

In yet another embodiment, the invention may provide a method of operating a down hole drill, the method generally including the steps of providing a bit having first and second opposite ends and defining a longitudinal axis extending between the first and second ends; the bit including a working surface at the first end, an enlarged diameter head at the second end, external splines, a shank portion between the enlarged diameter head and the external splines and having an outer diameter smaller than the outer diameter of the enlarged diameter head, and a retention portion between the working surface and the external splines, an external surface of the retention portion defining a first retaining surface, providing a drill assembly that includes a casing, a chuck having internal splines, a split ring having an inner diameter larger than the outer diameter of the shank portion of the bit but smaller than the outer diameter of the enlarged diameter head of the bit, and a retention sleeve interconnected to the casing, an internal surface of the retention sleeve defining a second retaining surface, providing in one of the first and second retaining surfaces an axially-extending entry slot having at least one open end, an axially-extending retaining slot having at least one closed end, and a circumferentially-extending transverse slot communicating between the entry slot and transverse slot, and providing on the other of the first and second retaining surfaces a lug.

The method also includes coupling the bit and drilling assembly with the split ring surrounding a portion of the shank portion to resist axial removal of the bit from the drilling assembly due to abutment of the split ring and the enlarged diameter head, the chuck surrounding a portion of the external splines such that the external splines mesh with the internal splines to transfer torque from the drilling assembly to the bit, and with the lug received in the entry slot through axial movement of the lug through the open end, and moving the lug from the entry slot to the retaining slot by axially aligning the lug with the transverse slot and causing relative rotation between the bit and retention sleeve, operating the down hole drill in a hole with the lug in the retaining slot such that substantially no axial loading and substantially no torque loading is transferred between the lug and retaining slot.

In addition, the method includes, during operation of the down hole drill in the hole, breaking the bit at the shank portion such that the split ring does not resist axial movement of the first end of the bit out of the drilling assembly, raising the drilling assembly out of the hole, and, while raising the drilling assembly, bringing the lug and closed end of the retaining slot into abutment to raise the first end of the bit out of the hole with the drilling assembly.

One or more independent aspects of the invention will become apparent by consideration of the detailed description, claims and accompanying drawings.

### BRIEF DESCRIPTION OF THE DRAWINGS

FIG. 1 is a perspective view of a portion of a drill assembly including a retainer assembly.

FIG. 2 is an exploded perspective view of the portion of the drill assembly shown in FIG. 1.

FIG. 3 is a cross-sectional perspective view of the portion of the drill assembly shown in FIG. 1 with additional components.

FIG. 4 is a perspective view of the portion of the drill assembly shown in FIG. 1 with the chuck removed and the sleeve shown in phantom.

FIG. 5 is a side view of the portion of the drill assembly shown in FIG. 4 and illustrating engagement of a lug in a slot.

FIG. 6 is a side view similar to FIG. 5 and illustrating the lug in a retainer slot with the drill assembly in a standby condition.

FIG. 7 is a side view similar to FIG. 5 and illustrating the lug in the retainer slot with the drill assembly in an operating condition.

FIG. 8 is a side view similar to FIG. 5 and illustrating engagement of the lug with the retainer surface to retain a broken portion of the bit.

### DETAILED DESCRIPTION

Before any independent embodiments of the invention are explained in detail, it is to be understood that the invention is not limited in its application to the details of construction and the arrangement of components set forth in the following description or illustrated in the following drawings. The invention is capable of other independent embodiments and of being practiced or of being carried out in various ways.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

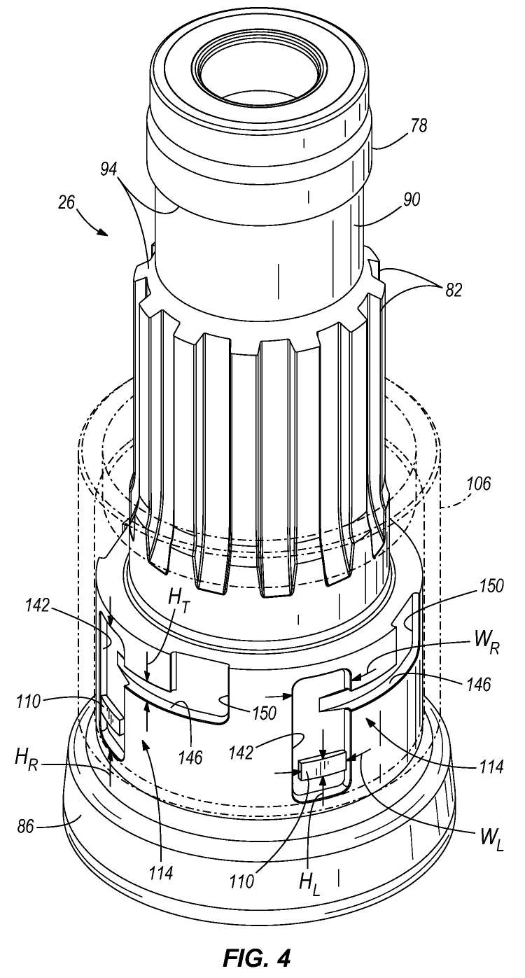

A down-hole drill assembly 10 is partially illustrated in the drawings. For the sake of simplicity and consistency, the term “axial” means in a direction along or parallel to a central axis 14 of the drill assembly 10 illustrated in the drawings. The elements of the drill assembly 10 discussed below are generally ring-shaped or cylindrical and therefore all have inner and outer surfaces. The term “inner surface” means the surface facing toward the central axis 14 or generally toward the inside of the drill assembly 10, and the term “outer surface” means the surface facing away from the central axis 14 or generally away from the inside of the drill assembly 10. All elements also have first and second ends which, using the convention of the illustrated construction, will be referred to as “top” and “bottom” ends with respect to the typical operating orientation of the drill assembly 10, which orientation is illustrated in FIG. 4. Also, terms such as “above”, “elevated”, “below”, etc., describe a relative position while the drill assembly 10 is in the typical operating orientation.

The drill assembly 10 may have both rotary and impact aspects to the drilling operation or may be embodied in a pure down-the-hole (“DTH”) drill arrangement in which there is no rotary component. The drill assembly 10 may use substantially any type of drill bit, including a standard bit, drag bit, rotary bit, or another cutting surface suitable for or adaptable to impact loading.

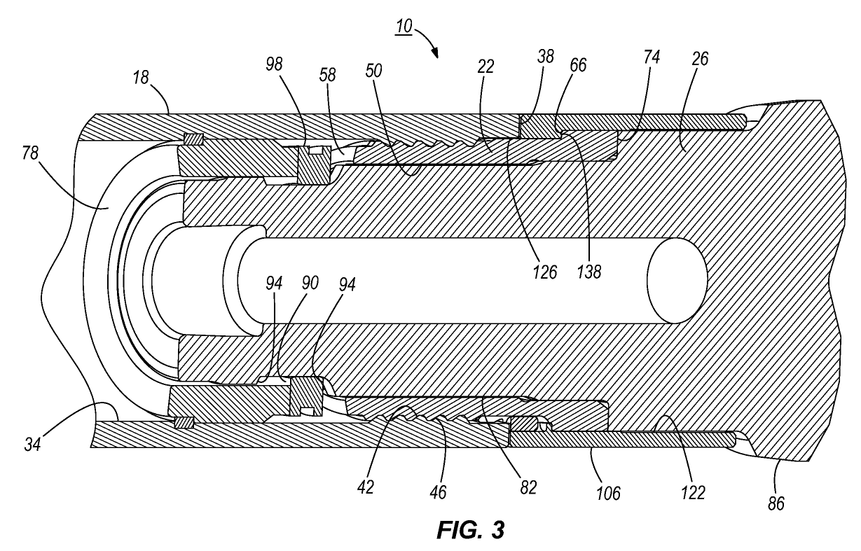

In the illustrated construction, the drill assembly 10 generally includes a casing 18 (shown in FIG. 3), a chuck 22, a bit 26 and a retainer assembly 30 operable to retain and retrieve a broken portion of the bit 26. The casing 18 defines a central bore 34 (see FIG. 3) for guiding a piston mechanism (not shown). The piston mechanism may be any type of piston mechanism usable in a drill assembly and, for example, may be similar to that shown in U.S. Patent Application Publication No. 2008/0078584 A1, published Apr. 3, 2008, and in U.S. patent application Ser. No. 12/369,579, filed Feb. 11, 2009, the entire contents of which are hereby incorporated by references.

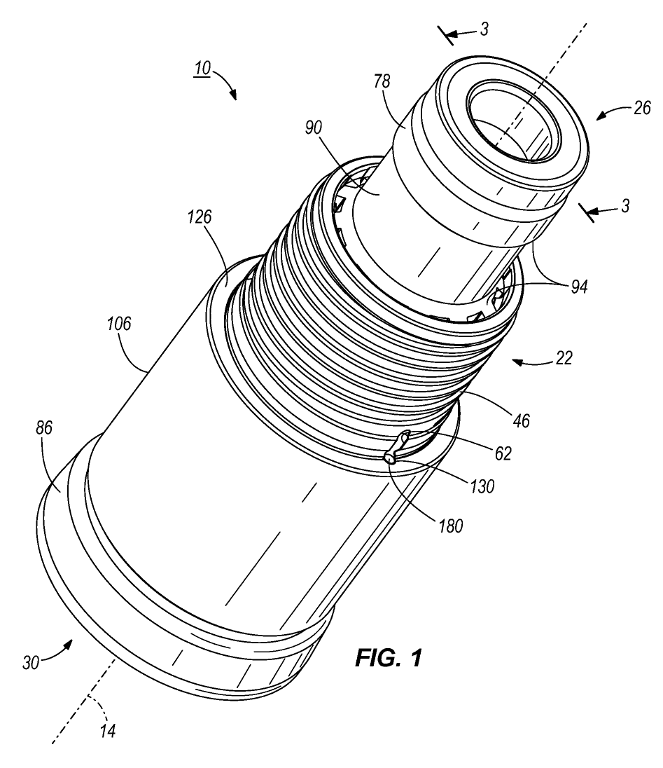

The casing 18 has a bottom end surface 38, and internal threads 42 are defined proximate the bottom end. As shown in FIGS. 1-3, the chuck 22 has outer threads 46 which mate with the threads 42 to connect the chuck 22 to the casing 18.

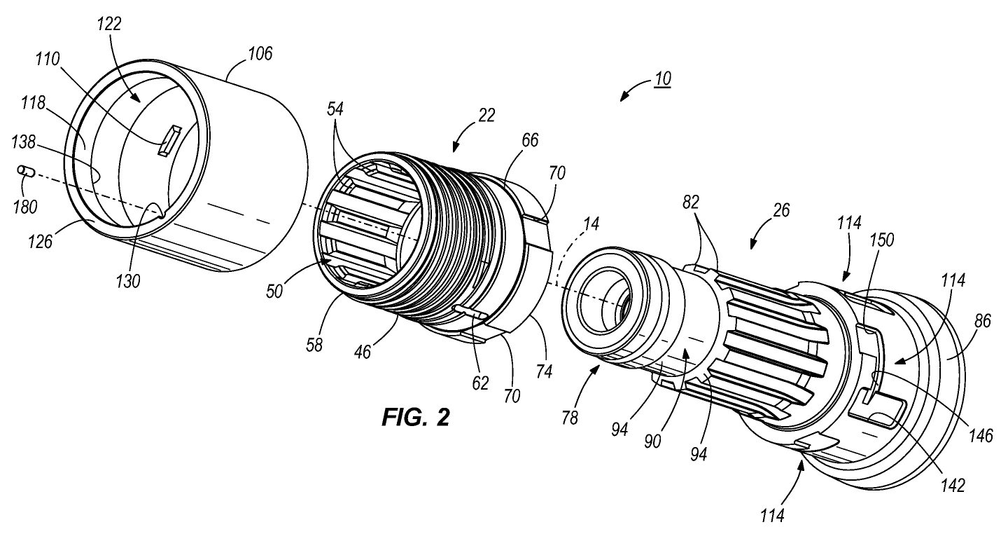

The chuck 22 defines (see FIG. 2) a chuck bore 50 and internal splines 54 extending from the upper end 58. A key recess 62 and an outer shoulder 66 are provided on the outer surface of the chuck 22. A number of slots 70 (four in the illustrated construction) extend axially between the outer shoulder 66 to the bottom end 74.

The bit 26 generally includes a shank 78 providing an anvil, an intermediate portion with external splines 82, and a head 86 having an exterior working surface to bear against rock or other material to be drilled. The bit shank 78 defines an annular groove 90 providing oppositely-facing stopping surfaces 94. When the bit 26 is assembled into the chuck 22, a split ring 98 (see FIG. 3) is positioned in the annular groove 90 to connect the bit 26 to the chuck 22 for drilling operations.

In the illustrated construction, the bit 26 is integrally formed to include the shank 78, intermediate portion and the head 86. In other constructions (not shown), the bit 26 could be formed as a bit retainer having suitable connecting apparatus for receiving a rotary drill bit (e.g., a tricone) or other suitable work piece for rock drilling.

As shown in FIGS. 2 and 4-8, the retainer assembly 30 generally includes a retainer sleeve 106 and an arrangement of inter-engaging lug(s) 110 and slot(s) 114. The sleeve 106 has an inner wall 118 defining a central bore 122. At the upper end surface 126, a key recess 130 is provided and is alignable with the key recess 62. The sleeve 106 also has an inner shoulder 138.

In the illustrated construction, the inner wall 118 of the sleeve 106 is machined to be formed with four (4) lugs 110, and the outer surface of the bit head 86 is formed with four (4) corresponding slots 114. As described below in more detail, each lug 110 is engageable in a corresponding slot 114. In the illustrated construction, the lugs 110 and slots 114 are equally spaced about the circumference of the sleeve 106 and the bit head 86, respectively.

It should be understood that fewer or more than four (4) lugs 110 and slots 114 may be provided. Also, in other constructions (not shown), the lug(s) 110 may be provided on the bit head 86, and the slot(s) 114 may be provided on the sleeve 106. In addition, corresponding numbers of lug(s) 110 and slot(s) 114 could be formed on each of the bit head 86 and the other structure (e.g., the sleeve 106). Further, in other constructions (not shown), a sleeve 106 may not be provided, and the lug(s) 110 and/or the slot(s) 114 may be provided on another structure (e.g., on a portion of the chuck 22).

It should be understood that the lug(s) 110 may be separate from and connectable (e.g., by welding) to the supporting structure (e.g., to the sleeve 106 or to the bit head 86). Also, in other constructions (not shown), the lug(s) 110 and the slot(s) 114 may be un-equally spaced about the circumference of and/or staggered along the axis of the sleeve 106 and the bit head 86, respectively, such that the lug(s) 110 and slot(s) 114 are only engageable in a limited number (e.g., one) of rotational positions of the bit head 86 relative to the sleeve 106.

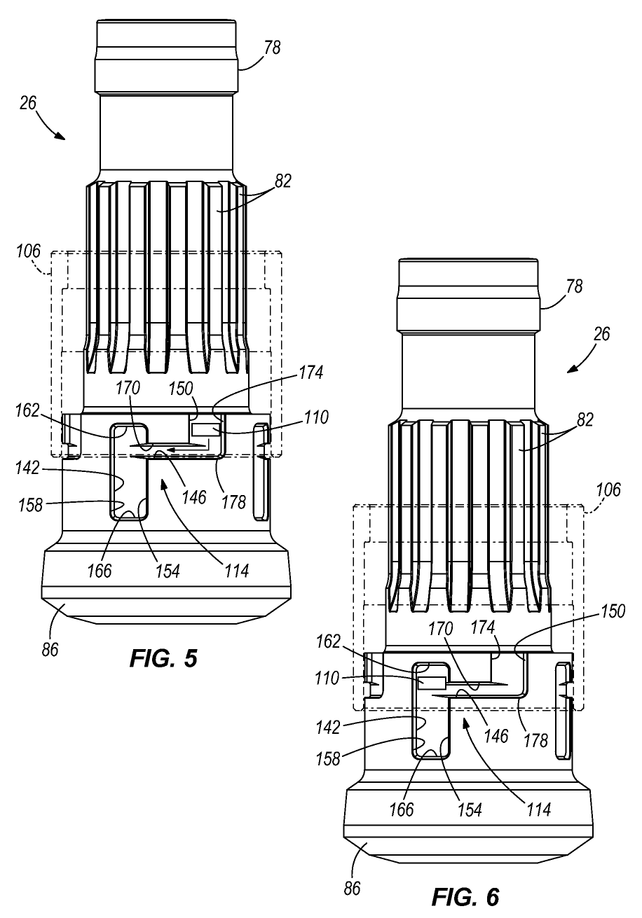

In the illustrated construction, each slot 114 includes several slot portions including an axial retainer slot 142, a transverse slot 146 and an entry slot 150. The retainer slot 142 has at least one closed end to prevent movement of the lug 110 from at least that end of the retainer slot 142. As shown in FIGS. 5-8, the retainer slot 142 has opposite side walls 154 and 158 and opposite end walls 162 and 166. One side wall (e.g., side wall 154) defines an opening 170. One end wall (e.g., the upper end wall 162) provides the at least one retainer end wall engageable with a surface of the lug 110 to prevent movement of the lug 110 from that end of the retainer slot 142.

The transverse slot 146 communicates with the retainer slot 142 through the opening 170 in the side wall 154. The entry slot 150 has at least one open end to allow movement of the lug 110 into/out of at least that end of the entry slot 150. The entry slot 150 has an entry port or open axial end 174 providing the at least one open end. The entry slot 150 communicates with the transverse slot 146 proximate its closed axial end 178. In the illustrated construction, each slot 114 generally has the shape of a reversed “4”.

In other constructions (not shown), each slot 114 may include fewer or more slot portions. For example, each slot 114 may include only a retainer slot 142 with an opening 170 for passage of the lug 110 into the retainer slot 142. In other constructions (not shown), each slot 114 may have a “J” shape.

To assemble, the bit shank 78 is inserted into the chuck bore 50, and the splines 54 and 82 are engaged or mesh such that torque may be transmitted from the chuck 22 to the bit 26. The split ring 98 is positioned in the annular groove 90 to connect the bit 26 to the chuck 22. For normal operations, axial movement is provided between the bit 26 and the chuck 22 while the splines 54 and 82 remain in torque-transmitting engagement. Engagement of the split ring 98 with the opposite stopping surfaces 94 limits this axial movement.

After (or before) connection of the bit 26 and the chuck 22, the sleeve 106 is lowered axially onto upper end 58 the chuck 22. Each lug 110 passes axially through an associated slot 70 in the outer surface of the chuck 22. Engagement of the inner shoulder 138 on the sleeve 106 with the outer shoulder 66 on the chuck 22 prevents further downward axial movement.

To engage the retainer assembly 30, each lug 110 enters the open axial end 174 of the entry slot 150 of its associated slot 114 and moves toward the closed axial end 178 as the bit 26 and sleeve 106 are moved axially relative to one another (as shown in FIG. 5). With the lug 110 proximate the closed axial end 178, the bit 26 and sleeve 106 are relatively rotated or angularly displaced so that the lug 110 enters the transverse slot 146. The relative rotation continues until the lug 110 passes through the opening 170 and into the retainer slot 142 (as shown in FIG. 6). In the illustrated construction, rotation of the sleeve 106 relative to the bit 26 is in the direction of normal rotation of the drill assembly 10.

Once the lug 110 is fully in the retainer slot 142, the bit 26 may move axially relative to the sleeve 106 and relative to the chuck 22 (as shown in FIGS. 6-8). Thereafter, to restrict relative rotational movement between the sleeve 106 and the chuck 22, a key 180 is received in the key recesses 62 and 130 to pin the sleeve 106 to the chuck 22.

With the chuck 22, the bit 26 and the retainer assembly 30 assembled, the unit is connected to the casing 18 by threading the chuck threads 46 into the casing threads 42 (as shown in FIG. 3). The bottom end surface 38 of the casing 18 engages the upper end surface 126 of the sleeve 106 to clamp the sleeve 106 in position.

Operation of the drill assembly 10 is explained with partial reference to FIGS. 6-8. When the bit head 86 is not being pushed against rock and the bit 26 is simply subject to forces arising from gravity, the bit 26 is extended downwardly and bottoms out with the upper stopping surface 94 resting on top of the split ring 98. In this standby condition of the drill assembly 10, the lug 110 is generally in the position in the retainer slot 142 shown in FIG. 6 with the lug 110 axially offset from the opening 170. As such, the lug 110 is prevented from inadvertently disengaging the retainer slot 142 through the opening 170.

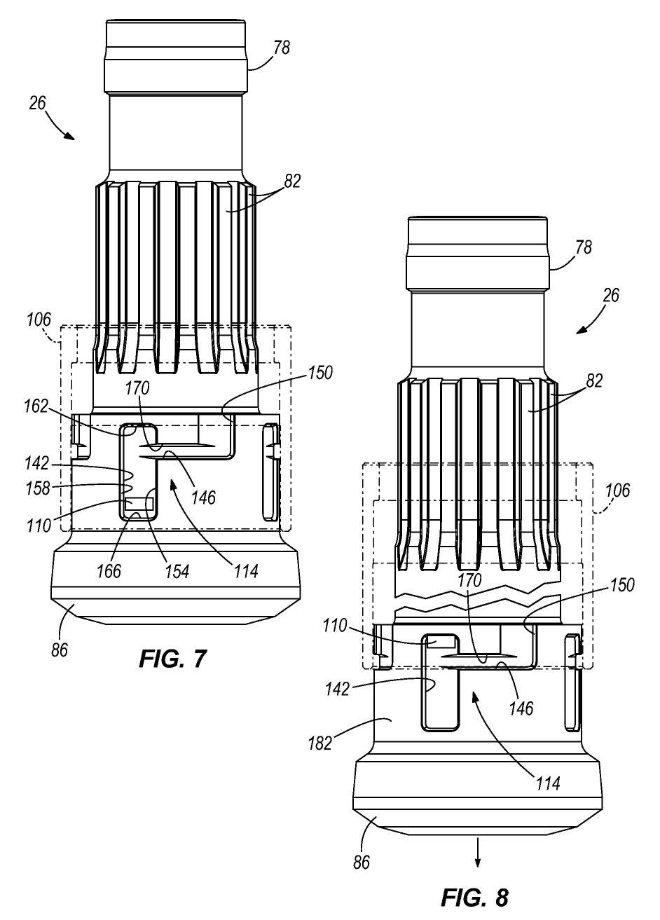

With reference to FIG. 7, when the bit head 86 is engaged against rock, the bit 26 is pushed upwardly and tops out with the lower stopping surface 94 abutting the bottom of the split ring 98 and the top of the bit head 86 bearing against the bottom end 74 of the chuck 22. In this operating condition of the drill assembly 10, the lug 110 is generally in the position in the retainer slot 142 shown in FIG. 7.

In operation, the drill assembly 10 has a rotary component (at least to change the engagement of teeth on the bit 26 with the bottom of the hole) and a percussive component. The impact of a piston (not shown) of the piston mechanism on the bit 26 is transmitted to the rock or other material being drilled, and the bit 26 moves axially in the chuck 22.

If the bit 26 fails during drilling operations, failure typically occurs in the shank 78 at the split ring 98, in the splines 82 or at the interface between the intermediate portion and the bit head 86. With such a failure, (see FIG. 8) the broken portion 182 of the bit 26 is no longer supported by engagement of the annular groove 90 with the split ring 98 and drops downwardly. However, the broken portion 182 is retained with the drill assembly 10 through engagement of the retainer assembly 30 and thereby may be retrieved from the hole.

As shown in FIG. 8, the upper surface of the lug 110 engages the retainer surface of the retainer slot 142 provided by the upper end wall 162 preventing the broken portion 182 from further downward movement and from disconnecting from the drill assembly 10. In this position, the lug 110 is trapped in the upper portion of the retainer slot 142, preventing disengagement while the drill assembly 10 is removed from the hole.

As shown in FIG. 4, each lug 110 has an axial height H_{L}. In the illustrated construction, the transverse slot 146 has an axial height H_{T} which fits closely to the height H_{L} of the lug 110 to reduce the likelihood that the lug 110 may inadvertently (e.g., during normal operation of the drilling assembly 10) move circumferentially from (e.g., disengage) the retainer slot 142, through the opening 170 and into the transverse slot 146. The height H_{T} of the transverse slot 146 may be between about 5% and about 50% larger and, in the illustrated construction, is about 20% larger than the height H_{L} of the lug 110. The opening 170 may have the same axial height as the transverse slot 146. The opening 170 may also be approximately square to further resist accidental disengagement of the lug 110 from the retainer slot 142.

In other constructions (not shown), the opening 170 may have a smaller axial height than the transverse slot 146. The transverse slot 146 may taper in height from the entry slot 150 toward the retainer slot 142.

The lug 110 and the retainer slot 142 are dimensioned and/or positioned on the supporting components (e.g., on the sleeve 106 and the bit 26) such that the lug 110 and the retainer slot 142 do not support and/or drive the bit 26 during operations. This arrangement ensures proper driving and/or support of the bit 26 while preventing wear and/or damage to the lug 110, the slot 114 and/or the supporting structure (the bit head 86 and the sleeve 106).

The retainer slot 142 has an axial height H_{R} which is greater than the total of the height of the lug H_{L} and the total axial movement of the bit 26 during drilling operations (as defined by the stopping surfaces 94 and the split ring 98). As shown in FIGS. 6, the upper surface of the lug 110 will not engage the upper end wall 162 when the bit 26 is not engaged with the rock, and, as shown in FIG. 7, the lower surface of the lug 110 will not engage the lower end wall 166 when the bit head 86 is engaged against the rock. The lug 110 will only engage the retainer slot 142 (the retainer surface of the upper end wall 162) when the bit 26 is broken.

Each lug 110 has a circumferential width W_{L}. In the illustrated construction, the retainer slot 142 has a larger circumferential width W_{R} such that the lug 110 will not engage the side walls 154 and 158 during normal operation of the drill assembly 10 (e.g., due to backlash in the splines 54 and 82). The width W_{R} is at least larger than the total of the width W_{L} of the lug 110 and the maximum circumferential movement in each direction of the bit head 86 relative to the sleeve 106. The circumferential width of the entry slot 146 may also be larger than the width W_{L} of the lug 110 (as shown) to allow easy assembly or may fit more closely to the circumferential width W_{L} of the lug 110.

One independent advantage of the present drill assembly 10 and retainer assembly 30 may be to provide structure to retain and retrieve a broken portion 182 of a bit 26. Such structure may be simple and/or inexpensive to manufacture, assemble and/or operate. Such structure may have improved operational reliability.

Thus, the invention provides, among other things, a retainer device for a drill bit for an earth-boring drill assembly. The invention also provides an earth-boring drill assembly. In addition, the invention provides a method of retaining a drill bit for an earth-boring drill assembly. Further, the invention provides a method of operating a down hole drill. Various independent features and independent advantages of the invention are set forth in the following claims.

What is claimed is:

1. A retainer device for a drill bit for an earth-boring drill assembly, the drill assembly including a casing having a central axis, the bit having a generally cylindrical head, the retainer device comprising:
an annular sleeve connectable to the casing; and
a retainer assembly provided between the sleeve and the bit, the retainer assembly including
an axial slot defined by one of the sleeve and the bit, the slot having an axially-extending side wall defining an opening and an axial end wall, and
a lug supported on the other of the sleeve and the bit, the lug being positionable in the slot through the opening in the side wall, the lug being engageable with the end wall to restrict axial movement of the bit from the sleeve and away from the casing.

2. The retainer device of claim 1, wherein the head of the bit has an outer circumferential surface, wherein the slot is defined on the outer circumferential surface of the head of the bit, and wherein the lug is supported by the sleeve.

3. The retainer device of claim 1, wherein the lug is integrally formed with the other of the sleeve and the bit.

4. The retainer device of claim 1, wherein the retainer assembly includes
a first axial slot defined by one of the sleeve and the bit, the first slot having an axially-extending first side wall defining an opening, an opposite second side wall, and an end wall between the first side wall and the second side wall,
a first lug supported on the other of the sleeve and the bit, the first lug being positionable in the first slot through the opening in the first side wall of the first slot, the first lug being engageable with the end wall of the first slot to restrict axial movement of the bit from the sleeve and away from the casing,
a second axial slot defined by one of the sleeve and the bit, the second slot having an axially-extending first side wall defining an opening, an opposite second side wall, and an end wall between the first side wall and the second side wall, and
a second lug supported on the other of the sleeve and the bit, the second lug being positionable in the second slot through the opening in the first side wall of the second slot, the second lug being engageable with the end wall of the second slot to restrict axial movement of the bit from the sleeve and away from the casing.

5. The retainer device of claim 4, wherein the head of the bit has an outer circumferential surface, wherein the first slot and the second slot are defined on the outer circumferential surface of the head of the bit, and wherein the first lug and the second lug are supported by the sleeve.

6. The retainer device of claim 1, wherein the retainer assembly includes
a plurality of axial slots defined by one of the sleeve and the bit, each of the slots having an axially-extending first side wall defining an opening, an opposite second side wall, and an end wall between the first side wall and the second side wall, the plurality of slots being circumferentially spaced about the one of the sleeve and the bit, and
a corresponding plurality of lugs supported on the other of the sleeve and the bit, each of the lugs being positionable in a corresponding one of the slots through the opening in the first side wall of the corresponding one of the slots, each of the lugs being engageable with the end wall of the corresponding one of the slots to restrict axial movement of the bit from the sleeve and away from the casing.

7. The retainer device of claim 6, wherein the retainer assembly includes four slots and four lugs.

8. The retainer device of claim 1, wherein the retainer assembly further includes a transverse slot extending at least partially circumferentially about the one of the sleeve and the bit, the transverse slot communicating with the axial slot through the opening in the side wall of the axial slot, the lug being movable into and through the transverse slot into the axial slot.

9. The retainer device of claim 8, wherein the retainer assembly further includes an axial entry slot having an open axial end, the lug being axially engageable in the entry slot through the open axial end, and wherein the transverse slot communicates between the entry slot and the axial slot.

10. The retainer device of claim 9, wherein the entry slot has a closed axial end opposite the open axial end, and wherein the transverse slot communicates with the entry slot proximate the closed axial end.

11. The retainer device of claim 1, wherein the axial slot has an axial second end wall opposite the first-mentioned end wall, the opening in the side wall being between the first-mentioned end wall and the second end wall.

12. The retainer device of claim 1, wherein the lug has an axial height, and wherein the opening in the first-mentioned side wall is sized to closely fit the axial height of the lug.

13. The retainer device of claim 1, wherein, during operation of the drill assembly, the bit moves an axial distance between a first operating position and a second operating position, wherein the lug has an axial height, and wherein the slot has an axial length greater than the total of the axial distance and the axial height of the lug.

14. The retainer device of claim 1, wherein, during operation of the drill assembly, the bit moves a circumferential distance between a first operating position and a second operating position, wherein the lug has a circumferential width, and wherein the slot has a circumferential width greater than the total of the circumferential distance and the circumferential width of the lug.

15. The retainer device of claim 1, wherein, during operation of the drill assembly, the bit moves axially between a first operating position and a second operating position, and wherein the slot and the lug are dimensioned such that the lug is engageable with the end wall of the slot in an axial position of the bit axially beyond the first operating position and the second operating position.

16. The retainer device of claim 1, wherein, during operation of the drill assembly, the bit moves circumferentially between a first operating position and a second operating position, wherein the slot has a second side wall opposite the first-mentioned side wall, and wherein the slot and the lug are dimensioned such that the lug is engageable with first-mentioned side wall of the slot in a circumferential position of the bit circumferentially beyond the first operating position and with the second side wall of the slot in a circumferential position of the bit circumferentially beyond the second operating position.

17. An earth-boring drill assembly comprising:
a casing having a central axis;
a bit having a generally cylindrical head and a shank connected to the head;
a chuck connected to the casing, the chuck being connected to the shank of the bit; and
a retainer device including
an annular sleeve connectable to the chuck; and
a retainer assembly provided between the sleeve and the bit, the retainer assembly including
an axial slot defined by one of the sleeve and the bit, the slot having an axially-extending side wall defining an opening and an axial end wall, and
a lug supported on the other of the sleeve and the bit, the lug being positionable in the slot through the opening in the side wall, the lug being engageable with the end wall to restrict axial movement of the bit from the sleeve and away from the casing.

18. The drill assembly of claim 17, wherein the chuck and the sleeve include inter-engaging surfaces to axially retain the sleeve on the chuck.

19. The retainer device of claim 17, wherein, during operation of the drill assembly, the bit moves an axial distance between a first operating position and a second operating position, wherein the lug has an axial height, and wherein the slot has an axial length greater than the total of the axial distance and the axial height of the lug.

20. The retainer device of claim 17, wherein, during operation of the drill assembly, the bit moves a circumferential distance between a first operating position and a second operating position, wherein the lug has a circumferential width, and wherein the slot has a circumferential width greater than the total of the circumferential distance and the circumferential width of the lug.

21. The retainer device of claim 17, wherein, during operation of the drill assembly, the bit moves axially between a first operating position and a second operating position, and wherein the slot and the lug are dimensioned such that the lug is engageable with the end wall of the slot in an axial position of the bit axially beyond the first operating position and the second operating position.

22. The retainer device of claim 17, wherein, during operation of the drill assembly, the bit moves circumferentially between a first operating position and a second operating position, wherein the slot has a second side wall opposite the first-mentioned side wall, and wherein the slot and the lug are dimensioned such that the lug is engageable with first-mentioned side wall of the slot in a circumferential position of the bit circumferentially beyond the first operating position and with the second side wall of the slot in a circumferential position of the bit circumferentially beyond the second operating position.

23. A method of retaining a drill bit for an earth-boring drill assembly, the drill assembly including a casing having a central axis, the bit having a generally cylindrical head, the method comprising:
(a) connecting an annular sleeve to the casing; and
(b) engaging a retainer assembly provided between the sleeve and the bit, the retainer assembly including an axial slot defined by one of the sleeve and the bit, the slot having an axially-extending first side wall defining an opening, an opposite second side wall, and an end wall between the first side wall and the second side wall, and a lug supported on the other of the sleeve and the bit, the act of engaging including
(i) positioning the lug in the slot through the opening in the first side wall, and
(ii) engaging the lug with the end wall to restrict axial movement of the bit from the sleeve and away from the casing.

24. A method of operating a down hole drill, the method comprising the steps of:
(a) providing a bit having first and second opposite ends and defining a longitudinal axis extending between the first and second ends; the bit including a working surface at the first end, an enlarged diameter head at the second end, external splines, a shank portion between the enlarged diameter head and the external splines and having an outer diameter smaller than the outer diameter of the enlarged diameter head, and a retention portion between the working surface and the external splines, an external surface of the retention portion defining a first retaining surface;
(b) providing a drill assembly that includes a casing, a chuck having internal splines, a split ring having an inner diameter larger than the outer diameter of the shank portion of the bit but smaller than the outer diameter of the enlarged diameter head of the bit, and a retention sleeve interconnected to the casing, an internal surface of the retention sleeve defining a second retaining surface;
(c) providing in one of the first and second retaining surfaces an axially-extending entry slot having at least one open end, an axially-extending retaining slot having at least one closed end, and a circumferentially-extending transverse slot communicating between the entry slot and transverse slot;
(d) providing on the other of the first and second retaining surfaces a lug;
(e) coupling the bit and drilling assembly with the split ring surrounding a portion of the shank portion to resist axial removal of the bit from the drilling assembly due to abutment of the split ring and the enlarged diameter head, the chuck surrounding a portion of the external splines such that the external splines mesh with the internal splines to transfer torque from the drilling assembly to the bit, and with the lug received in the entry slot through axial movement of the lug through the open end;
(f) moving the lug from the entry slot to the retaining slot by axially aligning the lug with the transverse slot and causing relative rotation between the bit and retention sleeve;
(g) operating the down hole drill in a hole with the lug in the retaining slot such that substantially no axial loading and substantially no torque loading is transferred between the lug and retaining slot;
(h) during operation of the down hole drill in the hole, breaking the bit at the shank portion such that the split ring does not resist axial movement of the first end of the bit out of the drilling assembly;
(i) raising the drilling assembly out of the hole; and
(j) while raising the drilling assembly, bringing the lug and closed end of the retaining slot into abutment to raise the first end of the bit out of the hole with the drilling assembly.
